(19) United States
(12) Patent Application Publication
(10) Pub. No.: US 2025/0182992 A1
(43) Pub. Date: Jun. 5, 2025

(54) MODULAR ELECTRICAL PROTECTION DEVICE WITH CONTROL AND POWER MODULES

(71) Applicant: Schneider Electric Industries SAS, Rueil Malmaison (FR)

(72) Inventors: Eric Domejean, Voreppe (FR); Jérôme Brenguier, L'Albenc (FR); Frédéric Court, Saint-Nicolas-de-Macherin (FR)

(73) Assignee: Schneider Electric Industries SAS, Rueil Malmaison (FR)

(21) Appl. No.: 18/845,128

(22) PCT Filed: Apr. 3, 2023
(86) PCT No.: PCT/EP2023/058648

§ 371 Date: Sep. 9, 2024

(30) Foreign Application Priority Data
Apr. 4, 2022 (FR) FR2203047

(51) Int. Cl. H01H 71/02; H01H 71/10

(52) U.S. Cl. CPC H01H 71/02; H01H 71/10

(57) ABSTRACT

A modular electrical protection device including at least a power module and a control module. In order for the device to be particularly effective and versatile, while being able to be modified easily, the power module includes a mechanical disconnector, a static switch and a local control circuit, for commanding the static switch into an off state, and the control module includes a tripping device, for mechanically tripping switching of the mechanical disconnector, and a main control circuit, for controlling the tripping device and communicating with the local control circuit.

The present invention relates to a control module for an electrical protection device, to a power module for this electrical protection device, and to the electrical protection device comprising such modules.

Many electromechanical electrical protection devices, such as air circuit breakers and especially miniature circuit breakers (MCBs), are physically designed to trip on occurrence of one of more electrical faults the characteristics of which are predetermined. These faults are for example a short-circuit, an overload or a residual current.

To modify the characteristics of the fault detectable by this type of device, it is necessary to physically modify the protection device, for example by replacing a bimetal strip used to detect overload, an electromagnetic actuator used to detect short-circuits, or a toroid used to detect residual currents.

In addition, the breaking performance of the device is generally limited by the speed of movement of the separable contacts ensuring isolation and by the characteristics of the arc-extinguishing chamber, the aim of which is to extinguish any electric arc that appears in the air between the separable contacts.

As these known protection devices have set operating characteristics, it is necessary to provide many classes of different devices, which are each suitable for one limited field of application. In addition, these known protection devices are difficult to adapt to certain particular applications, in which a high level of performance is required and/or the faults to be detected change during use of the device. For example, in a datacentre, provision may be made for the protection device to normally be supplied with electrical power using an AC current, and, in case of failure of this power supply, for it to be supplied with power using a DC current, delivered by standby batteries for example. In this particular case, the faults to be detected are very different, between an AC supply and a DC supply. In addition, to protect the installation in case of appearance of an electrical fault while it is being supplied with DC current by packs of electrochemical batteries, it is necessary to break very large currents with a very low reaction time, of the order of a few microseconds for example.

Moreover, the number of poles to be protected may be different depending on the installation, which may for example be single-phase or multi-phase.

For the sake of compatibility with existing installations, it would also be desirable for the protection devices of the invention to be able to be contained in a casing having the same size as the casings of electromechanical protection devices.

The invention especially aims to achieve these objectives and to remedy the aforementioned drawbacks, by providing a new electrical protection device that is particularly effective and versatile, that may be easily modified so as to accommodate the number of poles of the installation to be protected and that is especially suitable for protecting an installation the characteristics and the electrical faults to be detected of which change during use.

One subject of the invention is a control module as such, configured to be integrated into a modular electrical protection device also comprising at least one power module, the control module comprising: a control compartment, intended to form one portion of a casing belonging to the modular electrical protection device; a tripping device, able to mechanically trip switching of a mechanical disconnector belonging to said at least one power module, from a conduction configuration to a separation configuration; and a main control circuit. The main control circuit is: placed inside the control compartment,
configured to be in communication with a local control circuit belonging to said at least one power module, the local control circuit being configured to command into an off state a static switch belonging to said at least one power module, and configured to command the tripping device to trip switching of the mechanical disconnector, when opening conditions are met.

Another subject of the invention is a power module as such, configured to be integrated into a modular electrical protection device also comprising a control module, the power module comprising: a power compartment, intended to form one portion of a casing belonging to the modular electrical protection device; an input terminal, able to be connected to an electrical power supply; an output terminal, able to be connected to a load intended to be electrically powered by the electrical power supply via said at least one power module; a mechanical disconnector, via which the terminals are electrically connected, which comprises separable contacts placed inside the power compartment, the mechanical disconnector being configured to switch between a conduction configuration, in which the separable contacts make mutual contact so as to conduct electrical current between the input terminal and the output terminal, and a separation configuration, in which the separable contacts are separated by an air gap so as to electrically separate the output terminal from the input terminal, the mechanical disconnector being configured so that switching from the conduction configuration to the separation configuration is able to be mechanically tripped by a tripping device belonging to the control module; a static switch, via which the terminals are electrically connected, which is connected in series with the mechanical disconnector and which is configured to transition between an on state, for conducting electrical current between the input terminal and the output terminal, and an off state, for electrically isolating the output terminal from the input terminal; and a local control circuit, configured to command the static switch into the off state when opening conditions are met and to be in communication with a main control circuit belonging to the control module and controlling the tripping device.

Another subject of the invention is a modular electrical protection device, comprising: a casing; at least one power module such as defined above, the power compartment forming one portion of the casing; and a control module such as defined above, the control compartment forming one portion of the casing, the tripping device being able to mechanically trip switching of the mechanical disconnector of said at least one power module from the conduction configuration to the separation configuration, the main control circuit being in communication with the local control circuit of said at least one power module.

In other words, the modular device comprises a casing, a control module and at least one power module, for example one, two, three or four power modules. Each power module comprises: a power compartment forming one portion of the casing; an input terminal, able to be connected to an electrical power supply; an output terminal, able to be connected to a load intended to be electrically powered by the electrical power supply via said at least one power module; a mechanical disconnector, via which the terminals are electrically connected, which comprises separable contacts placed inside the power compartment, the mechanical disconnector being configured to switch between a conduction configuration, in which the separable contacts make mutual contact so as to conduct electrical current between the input terminal and the output terminal, and a separation configuration, in which the separable contacts are separated by an air gap so as to electrically separate the output terminal from the input terminal; a static switch, via which the terminals are electrically connected, which is connected in series with the mechanical disconnector and which is configured to transition between an on state, for conducting electrical current between the input terminal and the output terminal, and an off state, for electrically isolating the output terminal from the input terminal; and a local control circuit, configured to command the static switch into the off state when opening conditions are met. The control module comprises: a control compartment, which forms one portion of the casing, the control and power compartments being distinct; a tripping device, which is able to mechanically trip switching of the mechanical disconnector of said at least one power module from the conduction configuration to the separation configuration; and a main control circuit, which is: placed inside the control compartment, in communication with a local control circuit of said at least one power module, and configured to command the tripping device to trip switching of the mechanical disconnector, when opening conditions are met.

One idea behind the invention is to make the protection device modular, so as to be able to provide as many power modules as necessary, in accordance with the number of poles of the installation to be protected, without major modification of the design of the protection device. In particular, the main control circuit is able to communicate with one or more local control circuits, depending on the number of power modules provided, without modification of design. In particular, the tripping device is able to make trip a single disconnector or a plurality of disconnectors, depending on the number of power modules provided. It is therefore not necessary to provide an individual actuator for each power module, to actuate the one or more disconnectors. In general, each static switch is provided with its associated local control circuit pre-assembled with the static switch, and hence it is industrially advantageous to provide a local control circuit for each power module. More generally, provision may be made for the power modules to be modules that are standard, or even identical to one another. It is therefore particularly easy to modify the protection device to adapt it to the installation, in that it is enough to modify the number of power modules and potentially to program the control circuits specifically for a given installation, to modify the opening conditions as required.

In addition, the protection device is effective in that, for each pole, the power module allows both relatively large currents to be broken rapidly, by virtue of the static switch, and galvanic isolation to be achieved via formation of an air gap using the disconnector. By programming the local control circuit and/or the main control circuit appropriately, opening conditions may be defined that correspond to various electrical faults specific to the installation, an installation supplied with DC current for example, or that would be difficult to detect with the conventional components of electromechanical devices.

The protection device may be easily adapted to an installation the characteristics and the electrical faults to be detected of which change during use, in that the control circuits may be programmed beforehand to take into account these changes once the installation has been equipped with the device. During use, depending on the context, the control circuits take account of the opening conditions detailed in respect of placement of the semiconductor switch in the off state and/or opening conditions detailed in respect of placement of the disconnector in the separation configuration, even if, for example, the electrical power supply delivers an AC current then a DC current.

Preferably, the tripping device comprises: a tripping mechanism placed in the control compartment and configured to switch between an armed configuration and a tripped configuration; and a tripping bar, which juts out of the control compartment into said at least one power module, the tripping bar being moved when the tripping mechanism transitions from the armed configuration to the tripped configuration, so that the tripping bar mechanically trips switching of the mechanical disconnector of the power module, from the conduction configuration to the separation configuration.

Preferably, the tripping device comprises a general manual control, which is borne by the control compartment and which is actuatable from outside the control compartment so as to command the tripping device to switch the disconnector of said at least one power module from the conduction configuration to the separation configuration.

Preferably, the tripping device comprises an electric actuator, which is placed inside the control compartment and which is controlled by the main control circuit, the main control circuit controlling the tripping device by controlling the electric actuator.

Preferably, the mechanical disconnector comprises a local manual control, which is borne by the power compartment and actuatable from outside the power compartment so as to switch the mechanical disconnector between the conduction configuration and the separation configuration.

Preferably, to determine whether the opening conditions are met, the local control circuit comprises a sensor system comprising: a current sensor, measuring the electrical current flowing between the terminals; and/or a command sensor, detecting actuation of the local manual control.

Preferably, the main control circuit comprises a remote-communication interface, for communicating with a remote device distinct from the modular electrical protection device.

Preferably, the main control circuit is supplied with electrical power by an auxiliary electrical power supply and the local control circuit of said at least one power module is electrically connected to the control module so that said local control circuit is electrically powered by the auxiliary electrical power supply, via the control module.

Preferably, the control module comprises an auxiliary electrical power supply component, which is placed in the control compartment while being connected to the electrical power supply, the auxiliary electrical power supply component delivering auxiliary electrical power to the main control circuit via conversion of the electrical power supply.

Preferably, the auxiliary electrical power supply component is connected to the electrical power supply by being electrically connected to two power modules of the device, using wired connections, each wired connection being connected to its power module between the input terminal and the output terminal.

The invention also relates to an installation comprising: the aforementioned protection device; an electrical power supply, which is electrically connected to the input terminal of said at least one power module; and a load, which is electrically connected to the output terminal of said at least one power module so as to be electrically powered by the electrical power supply via the modular electrical protection device.

The invention will be better understood and other of its advantages will become more clearly apparent in light of the following description of examples of embodiment, which is given with reference to the attached drawings, which will now be briefly described.

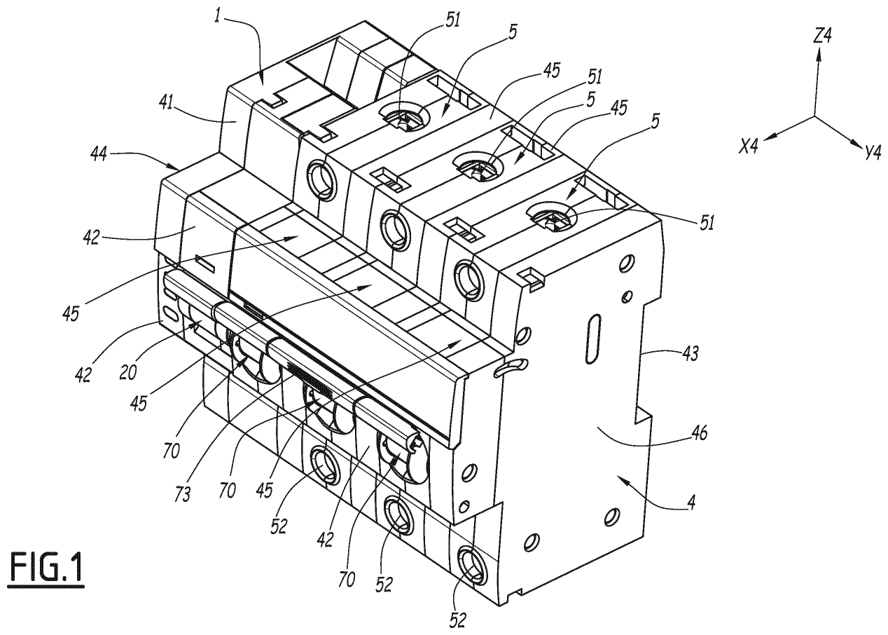

FIG. 1 is a perspective view of the protection device according to one embodiment of the invention.

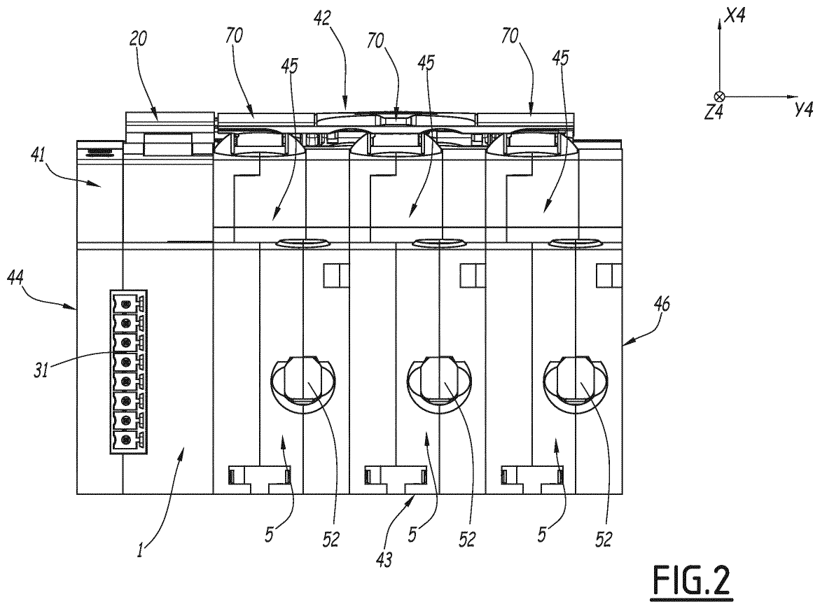

FIG. 2 is a view from below of the protection device of FIG. 1.

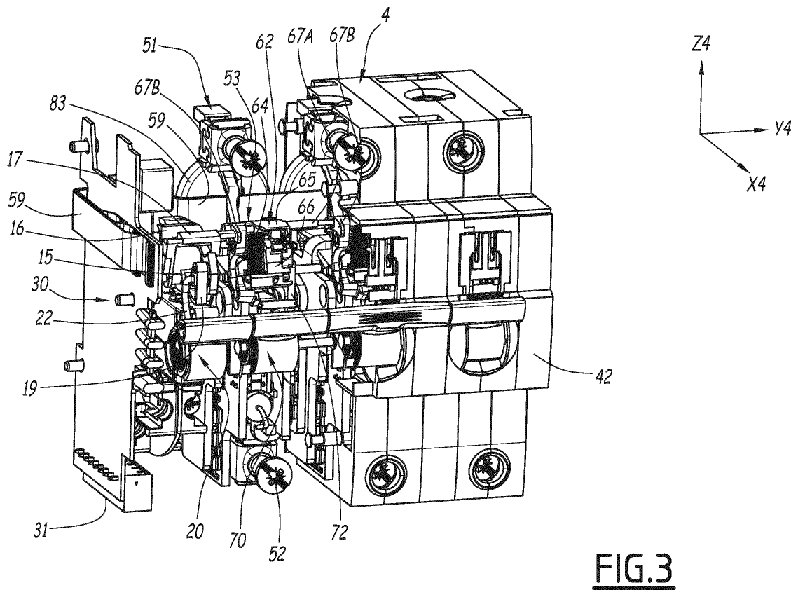

FIG. 3 is a perspective view of the protection device of the preceding figures, from another angle, one portion of the casing having been omitted.

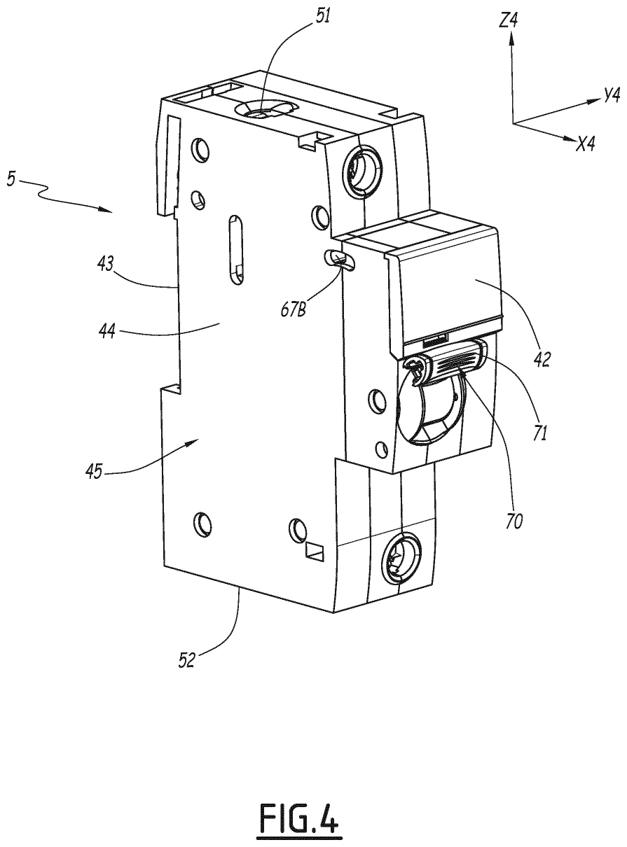

FIG. 4 is a side perspective view of a power module belonging to the protection device of the preceding figures.

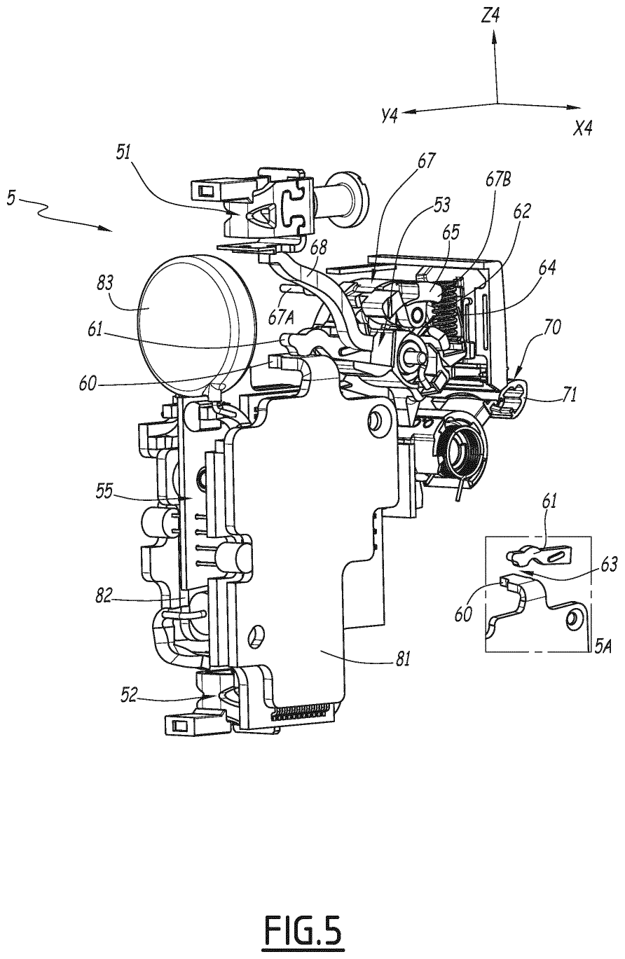

FIG. 5 is a back perspective view of the power module of FIG. 4, a power compartment, forming one portion of the casing of the protection device, having been omitted.

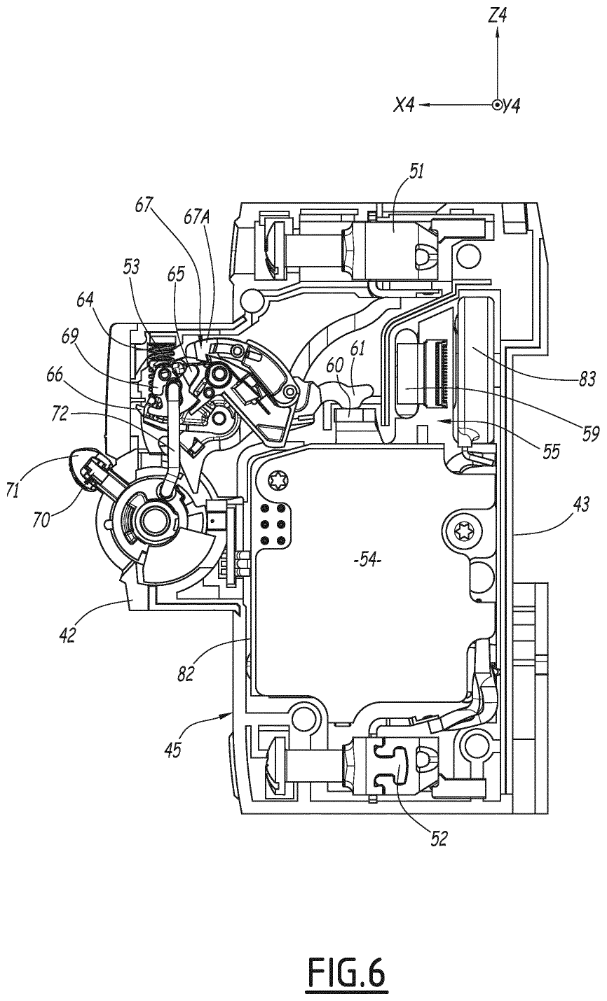

FIG. 6 is a side view of the power module of FIGS. 4 and 5, one portion of the power compartment having been omitted.

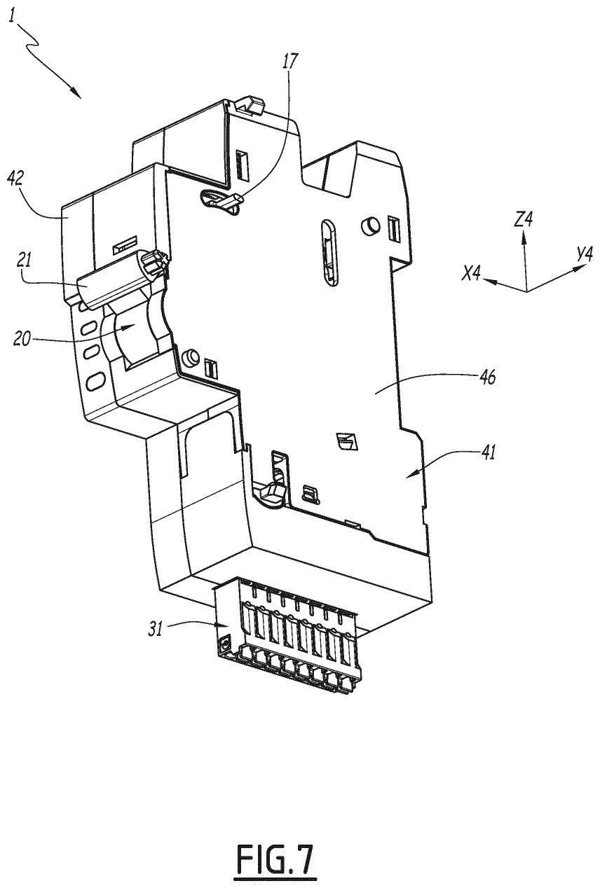

FIG. 7 is a bottom perspective view of a control module belonging to the protection device of the preceding figures.

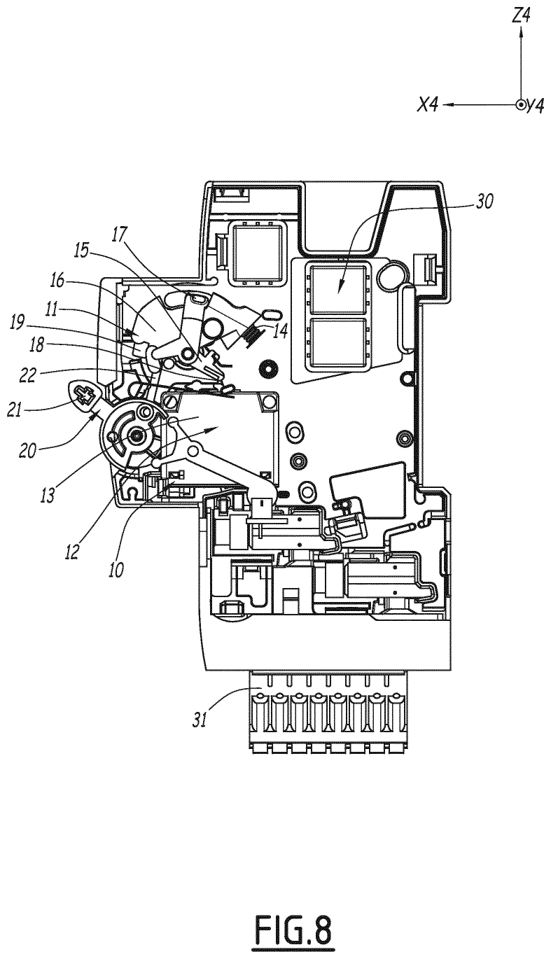

FIG. 8 is a side view of the control module of FIG. 7, one portion of a control compartment, forming one portion of the casing of the protection device, having been omitted.

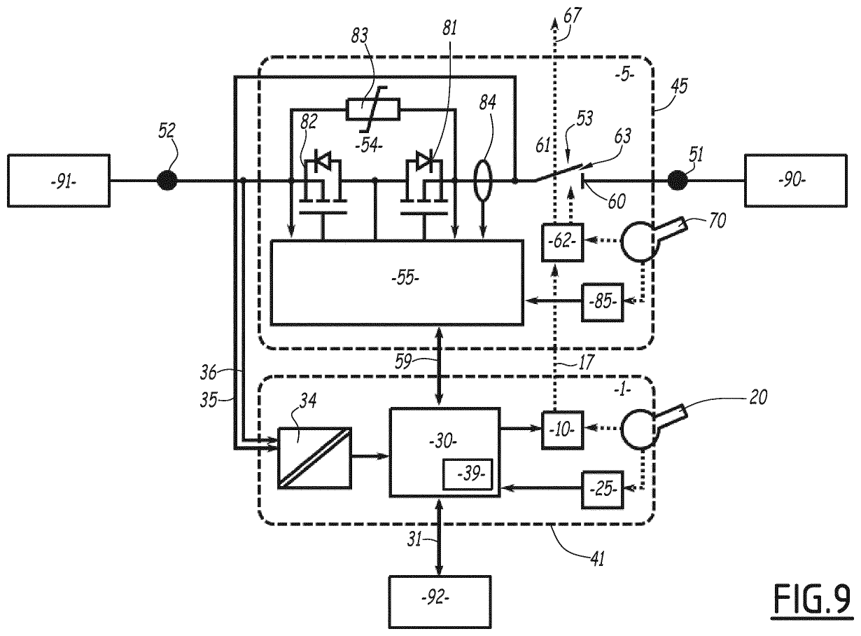

FIG. 9 is a functional diagram of the protection device of the preceding figures.

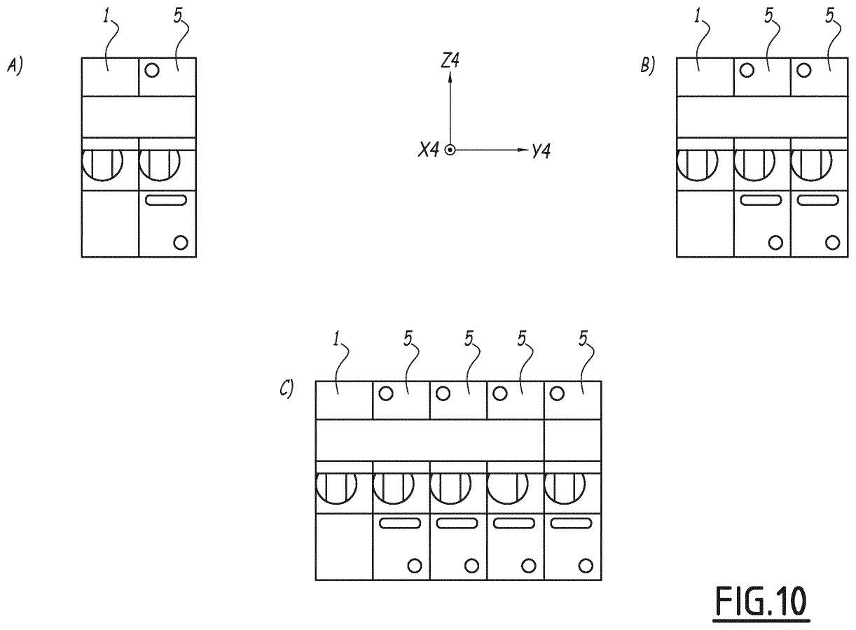

FIG. 10 shows three examples of protection devices according to the invention, with a number of power modules different to the embodiment of the preceding figures.

FIGS. 1 to 9 illustrate a modular electrical protection device, or “device” for short, the whole of which is shown in FIGS. 1 and 2, and with which an electrical installation is intended to be equipped, in order to provide electrical protection. Preferably, the device 2 is a miniature circuit breaker.

The device is modular in that it comprises a plurality of modules, here one control module 1 and three power modules 5, and in that the number and the arrangement of the modules may easily be modified, to adapt the device to various applications, and especially to the number of poles of the installation to be protected. At least a single power module 5 is provided. Preferably, as many power modules 5 as the installation comprises poles to be protected are provided. In the present case, the device allows three poles to be protected, as it comprises three modules 5. FIGS. 3-6 show one of the power modules 5 alone. FIGS. 7-8 show the control module 1 alone.

The device comprises a casing 4 inside of which are housed at least some of the components of the device.

A depth direction X4, a width direction Y4 and a height direction Z4 are defined, these being perpendicular to one another and fixed with respect to the casing 4. The casing 4 is preferably manufactured from a rigid, electrically insulating material such as a thermoformed polymer, the polyamide PA 6.6 for example. The casing 4 is at least partially, or even entirely, formed by an assembly of individual casings, forming compartments, each compartment belonging to one of the modules 1 and 5. The control module 1 comprises a compartment 41 called the “control compartment”, and each power module 5 comprises a respective compartment 45 called the “power compartment”. Each compartment 41 and 45 is distinct from the other compartments 41 or 45. The compartments 41 and 45 are adjacent one another, and not nested or contained in one another. The compartments 41 and 45 are fastened to one another, and hence the casing 4 forms a unitary assembly.

Preferably, each compartment 41 and 45 has similar dimensions, or dimensions that are multiples of a basic unit of measurement, in order to be able to be interchangeable and to give the device a modular character, while being compatible with existing installations. For example, each compartment 41 and 45 has a width, in the direction Y4, that is equal to 27 mm. Provision may for example be made for this width to be a multiple of 9 mm.

Each compartment 41 and 45 comprises a front 42 and a back 43, which are opposite in the direction X4, and a side 44 and side 46, which are opposite in the direction Y4 and which join the front 42 and the back 43 to each other. The sides 46 face in the direction Y4 and the sides 44 face in the opposite direction. The fronts 42 face in the direction X4 and the backs 43 face in the opposite direction. The modules 1 and 5 are assembled via their respective compartment 41 and 45, on being arranged in succession along the axis Y4. Here, the module 1 is placed at one end of the device, and is followed by the modules 5 which are placed in succession in the direction Y4 from the module 1. However, another order may be adopted. Each module 1 or 5 is assembled, via its side 46, against the adjacent module 1 or 5, via its side 44. To do this, the sides 44 and 46 advantageously comprise complementary fastening means, for example snap-fastening hooks. The sides 44 and 46 of the end modules that are left free form the sides of the casing 4. The fronts 42 of the modules 1 to 5 form the front of the casing 4. The backs 43 of the modules 1 to 5 form the back of the casing 4.

Preferably, the backs 43 of the modules 1 and 5 together form an attachment in order to allow the device to be fastened to a horizontal fastening rail, parallel to the direction Y4. Preferably, the front of the casing 4 is left accessible to an engineer when the device is integrated into the installation.

As shown in FIGS. 1 to 9, each power module 5 comprises an input terminal 51 and an output terminal 52, which are opposite in the direction Z4 and which open out of the power compartment 45. The terminal 51 is placed in the direction Z4 with respect to the terminal 52, and opens in the direction Z4. The terminal 52 opens in the opposite direction. Each terminal 51 and 52 for example takes the form of a screw terminal. Each terminal 51 and 52 is able to be electrically connected to a respective electrical conductor.

Each input terminal 51 is able to be electrically connected to one of the poles of an electrical power supply 90 of the installation. This pole may be a phase pole or a neutral pole, if the electrical power supply 90 is an AC power supply. This pole may also be a positive, negative or neutral pole if the installation is a DC installation. Provision may also be made for the pole to change function, especially when the electrical power supply 90 is capable of delivering a plurality of types of current during use, for example an AC current then a DC current. The electrical power supply 90 may comprise the mains, a standby system based on packs of batteries and/or an inverter. For example, the power supply 90 delivers an AC or DC voltage comprised between 100 and 1000 volts.

Each output terminal 52 is able to be electrically connected to one of the poles of a load 91, which is intended to be electrically powered by the electrical power supply 90 via the device. For each module 5, the pole of the load 91 to be connected to the terminal 52 corresponds to the pole of the electrical power supply connected to the terminal 51. For example, the load consists of a server farm, or an electrical network of a dwelling or building for use in the service sector.

The device of FIGS. 1 and 2 is configured to protect three poles of the installation, in that three power modules 5 are provided, each corresponding to one of the poles. However, as illustrated in FIG. 10, provision may be made for the device to be single-pole, with a single module 5 (case A in FIG. 10), for the device to be two-pole, with two modules 5 (case B in FIG. 10), or for the device to be four-pole (case C of FIG. 10). To achieve this, as many power modules 5 as there are poles to be protected are installed. In all cases, a single control module 1 is advantageously installed.

As may be better seen in FIGS. 5 and 6, and as functionally shown in FIG. 9, each power module 5 comprises a mechanical disconnector 53 and a static switch 54 and a local control circuit 55. In FIG. 9, a single one of the power modules 5 has been shown, but the others have a similar structure.

The mechanical disconnector 53 and the static switch 54 electrically connect the terminal 51 to the terminal 52 and are connected in series. In particular, the disconnector 53 connects the terminal 51 to the switch 54, and the switch connects the disconnector 53 to the terminal 52.

The mechanical disconnector 53 comprises separable contacts, namely a fixed contact 60 and a mobile contact 61 and a tripping mechanism 62. The contacts 60 and 61 and the mechanism 62 are entirely placed inside the power compartment 45. The fixed contact 60 is fixed with respect to the compartment 45, here by being securely fastened to the switch 54. The mobile contact 61 is able to move with respect to the compartment 45, on being actuated by the mechanism 62, and is electrically connected to the terminal 51 by an electrical conductor 68.

The mechanical disconnector 53 is configured to switch between a conduction configuration, which is shown in FIGS. 5 and 6, and in which the contacts 60 and 61 make mutual contact so as to conduct electrical current between the terminals 51 and 52, and a separation configuration, in which the contacts 60 and 61 are separated by an air gap 63, as shown in the detail 5A of FIG. 5, so as to electrically separate the terminals 51 and 52 from each other at the air gap 63.

To switch between these two configurations, the mechanism 62 actuates the contact 61 between a position in which the contact 61 is in abutment against the contact 60, as shown in FIGS. 5 and 6, and a position in which the contact 61 is distant from the contact 60 so as to no longer make contact with the contact 60 and thus to be separated therefrom by the air gap 63. Preferably, the mobile contact 61 includes a conductive portion, via which the mobile contact 61 makes contact with the fixed contact 60 so as to conduct the flow of the electrical current, and a contact holder, bearing the conductive portion and by way of which the contact 61 is actuated by the mechanism 62.

The mechanism 62 transitions between an armed configuration and a tripped configuration. The mechanism 62 advantageously comprises a spring 64, a locking system 65 and a pivoting deck 66.

The pivoting deck 66 is mounted so as to be able to pivot with respect to the compartment 45. The rotationwise position of the deck 66 constrains, or at least controls, the position of the contact 61. To this end, the deck 66 actuates the contact holder of the contact 61.

The spring 64 exerts a force on the deck 66 that tends to make the deck 66 pivot in a direction such as to make it move the contact 61 away from the contact 60. To this end, the spring 64 advantageously bears against a wall of the compartment 45.

The locking system 65, which is for example borne by the deck 66, allows, when it is locked and when the mechanism is in armed configuration, the deck 66 to be kept in an orientation such as to make the contacts 60 and 61 bear against each other.

Preferably, the locking system 65 comprises a keeper 69 and a trigger 67. The trigger 67 preferably comprises a tripping bar 67A and bar-detecting part 67B, which are securely fastened. The bar 67A and the part 67B are oriented in opposite directions to each other, parallel to the direction Y4.

The keeper 69 is mounted on the deck 66 in such a way as to be able to pivot with respect to the deck 66. The trigger 67 is mounted on the deck 66 in such a way as to be able to pivot with respect to the deck 66. The pivoting motions of the keeper 69 and of the trigger 67 are constrained by a bolt spring, which tends to return the keeper 69 and the trigger 67 to the locked configuration of the locking system 65. The keeper 69 and the trigger 67 may each be actuated against the force of the bolt spring, to release the locking system 65.

In conduction configuration, the mechanism 62 is in the armed configuration, in which the mechanism keeps the contacts 60 and 61 in mutual contact. In this armed configuration, the spring 64 is stretched to form a store of mechanical potential energy, and retained by the locked configuration of the locking system 65. To switch the mechanism 62 to the tripped configuration, the locking system 65 is released. This permits the deck 66 to be pivoted under the action of the spring 64. Thus, the spring 64 makes the deck 66 pivot, the deck moving the contact 61 until it separates from the contact 60 so as to obtain the air gap 63. The mechanism 62 thus reaches the tripped configuration and the disconnector 53 its separation configuration.

To return the mechanism 62 from the tripped configuration to the armed configuration, the mechanism 62 is actuated, for example via the locking system 65 or the deck 66, against the force of the spring 64, this re-stretching the spring 64 with a view to future tripping. Since the deck 66 is pivoted in the opposite direction, the deck moves the contact 61 until said contact 61 is brought into abutment against the contact 60. When the armed configuration is reached, the locking system 65 will have reached the locking configuration, under the action of its bolt spring, so as to once again prevent the spring 64 from switching the mechanism 62 to the tripped configuration. In armed configuration, the mechanism 63 keeps itself in the armed configuration until the locking system 65 is again released.

Provision is also made for the mechanical disconnector 53 to comprise a control 70, called the “local manual control”, which is a mechanical control. The control 70 is borne by the front 42 of the power compartment 45, in order to be able to be manually actuated by the engineer during use of the device, from outside the casing 4. The control 70 is actuatable to make the mechanical disconnector 53 switch between the conduction configuration and the separation configuration.

For example, the control 70 comprises a toggle switch 71, which juts out toward the exterior of the compartment 45, from the front 42, so as to be manually actuatable by the engineer. For example, the control 70 also comprises a linking rod 72 (shown in FIGS. 3 and 6) for mechanically linking the mechanism 62 to the toggle switch 71. Preferably, the linking rod 72 passes through the keeper 69 and links to the deck 66 so as to be able to unlock the locking system 65 by actuating the keeper 69. The toggle switch 71 is moveable between a closed position, which is shown in the figures, and which corresponds to the conduction configuration of the disconnector 53, and an open position, which corresponds to the separation configuration of the disconnector 53

When the disconnector 53 is in conduction configuration and the toggle switch 71 is moved to the open position, from the closed position, the toggle switch 71 unlocks the locking system 65 via the linking rod 72. When the spring 64 places the mechanism 62 in tripped configuration, the mechanism, on passing to the tripped configuration, drives the toggle switch 71 to the open position via the linking rod 72, which itself is driven by the locking system 65 and/or the deck 66.

When the disconnector 53 is in separation configuration and the toggle switch 71 is moved to the closed position, from the open position, the toggle switch 71 drives the mechanism 62, via the linking rod 72 actuating the deck 66, to the armed configuration, against the force of the spring 64, thus stretching the spring 64, until the conduction configuration is reached.

Other examples of mechanisms suitable for the invention are for example described in EP 2975628 B1 and EP 1542253 B1.

In separation configuration, the disconnector 53 ensures a galvanic separation of the terminals 51 and 52 from each other, and preferably, a galvanic separation of the terminal 51 with respect to the switch 54. It is advantageously not necessary to make provision for the mechanical disconnector 53 to comprise means allowing an electric arc to be quenched, such as an arc-extinguishing chamber, breaking capacity being ensured by the switch 54, as explained below.

If a plurality of power modules 5 are provided, provision is advantageously made for their mechanical disconnectors 53 to be mechanically coupled so that, when one of the disconnectors 53 switches between the conduction configuration and the separation configuration, the other disconnectors 53 also switch to the same configuration. Preferably, provision is made for each disconnector 53 to be mechanically coupled to the disconnector 53 of the one or more modules 5 that are adjacent thereto.

In the present example, provision is made for the disconnectors 53 to be mutually coupled via their respective mechanism 62. In particular, provision is made, for each pair of adjacent modules 5, for the tripping bar 67A of the first module 5 to actuate the locking system 65 of the adjacent second module 5, via mechanical interaction with the bar-detecting part 67B of this second module 5. To this end, for example, the tripping bar 67A mechanically links the two adjacent mechanisms 62, via passage through a notch provided in the side 46 of the first module 5 and a notch provided in the side 44 of the adjacent second module 5. To interact mechanically, the bar 67A is accommodated in a notch of the detecting part 67B. As a result thereof, the locking systems 65 of the adjacent modules 5 are synchronized, or even secured to one another, via their triggers 67. At the very least, the bar 67A of the first module 5 bears against the part 67B of the second module 5, so that switching of the locking system 65 of the first module 5 leads to switching of the locking system 65 of the second module 5. Contiguously, all the locking systems 65, and therefore all the mechanisms 62, of the device are thus mechanically synchronized via the triggers 67.

If a plurality of modules 5 are provided, provision may advantageously be made for their controls 70 to be mechanically coupled so that, when one of the controls 70 is actuated, the other controls 70 are actuated in the same way. To this end, preferably, provision is for example made for each toggle switch 71 of a first of the modules 5 to be mechanically secured to the one or more toggle switches 71 belonging to the module 5 or to the modules 5 that is (are) adjacent to this first module 5. To be secured, provision is for example made for the adjacent toggle switches 71 to be linked to one another by a linking part 73, or for them to be complementary. Contiguously, all the toggle switches 71, and therefore all the controls 70 of the device, are secured to one another and synchronized.

The switch 54 is configured to transition between an on state, for conducting electrical current between the terminals 51 and 52, and an off state, for electrically isolating the terminals 51 and 52 from each other. The switch 54 is configured to interrupt an electrical current between the terminals 51 and 52, including when the installation is on load.

The switch 54 is a “static” switch, i.e. in contrast to a mechanical switch it does not employ separable contacts to transition between the on state and the off state. To this end, the switch 54 comprises semiconductor-based switching components, such as power transistors, that are controlled electronically. The switch 54 does not comprise an arc-extinguishing chamber.

Preferably, the switch 54 is accommodated in a dedicated housing of the compartment 45. Even more preferably, when the compartment 45 is of the same type (or even identical) to those used in a standard electromechanical-protection-device casing, said housing corresponds to the space normally occupied by the arc-extinguishing chamber and by means for detecting an electrical fault (which means are for example so-called thermal and magnetic means), such as a bimetal and a coil, respectively. This makes it possible not to change the architecture of existing circuit breakers and to ensure compatibility with existing installations.

Since the switch 54 and the disconnector 53 are connected in series, the module 5 may transition between an open state (OFF), in which the switch 54 is in the off state and in which the disconnector 53 is in separation configuration, and an intermediate state (STANDBY), in which the switch is in the off state and in which the disconnector is in conduction configuration, and a closed state (ON), in which the switch 54 is in the on state and the disconnector 53 is in conduction configuration. In the closed state, the terminals 51 and 52 are electrically connected. In the other states, the terminals 51 and 52 are electrically isolated. In the open state, the terminals 51 and 52 are electrically isolated with galvanic isolation.

In the illustrated example, the static switch 54 comprises two power switches 81 and 82, which are electrically connected in series. The switch 81 is here connected to the disconnector 53 and to the switch 82, whereas the switch 82 is connected to the switch 81 and to the terminal 52. Each power switch may, in practice, be implemented via a plurality of components, such as transistors, connected in parallel, depending on the protection rating that it is desired to obtain.

For example, for a rating of sixteen amps, provision may be made to use two series-connected pairs of transistors, the transistors of each pair of transistors being connected in parallel. For a higher rating, for example thirty-two amps, it is possible to use a higher number of parallel-connected transistors.

Each power switch 81 and 82 is switchable between an electrically off state and an electrically on state. For example, the power switches 81 and 82 are power transistors, such as field-effect transistors, metal-oxide-semiconductor field-effect transistors (MOSFETs) for example. This type of transistor is preferred because it has a low on-state resistance, but also because it remains in the off state when it is at rest, for example when no control signal is sent to the control electrode. Other semiconductor technologies may however be envisaged depending on the rating of the circuit breaker, such as insulated-gate bipolar transistors (IGBTs), or thyristors, or integrated gate-commutated thyristors (IGCTs), or indeed yet other technologies. As a variant, the power switches 81 and 82 may be junction field-effect transistors (JFETs). In this case, operation of the control circuit 55 may need to be modified, to take into account the fact that such JFETs are in the on state when they are at rest.

A diode is advantageously present in parallel with each of the power switches 81 and 82, as illustrated in FIG. 9. Generally, it is a question of a parasitic diode inherent to the construction of the power switch.

The local control circuit 55 is coupled to the static switch 54 so as to control it. In other words, the electronic control circuit 55 allows the switch 54 to be driven. In the example, the circuit 55 is coupled to each switch 81 and 82. Physically, provision is advantageously made for the control circuit to be placed between the switches 81 and 82 in the direction Y4, as shown in FIG. 5, this facilitating interconnection.

Advantageously, the switch 54 may comprise one or more components 83 for protecting against overvoltages, which components are connected in parallel with the one or more power switches 81 and 82, in order to protect the power switches 81 and 82 against overvoltages, especially in case of appearance of an electric arc. This especially allows the switches 81 and 82 to be protected voltagewise on actuation of the circuit breaker in cases where the installation comprises inductive circuits. For example, a metal-oxide varistor (MOV) or a TVS diode (TVS standing for transient voltage suppression) is employed by way of protecting component.

Preferably, the control circuit 55 comprises a processor, such as a programmable microcontroller or a microprocessor. The processor is advantageously coupled to a computer memory, or to any computer-readable data storage medium that contains a program, i.e. executable instructions and/or software code. As variants (not described in detail), the control circuit 55 may comprise a digital signal processor (DSP), or a field-programmable gate array (FPGA), or an application-specific integrated circuit (ASIC), or any equivalent element or any combination of these elements.

When the program is executed by the processor or the other aforementioned components, it implements a method in which the control circuit 55 commands the switch 54 to switch from the on state to the off state and vice versa. In particular, the method is set up so that the circuit 55 makes the switch 54 switch from the on state to the off state when opening conditions are met. By “opening conditions”, what is meant is one or more conditions that, when they are considered to be met by the control circuit 55, result in the circuit 55 ordering the switch 54 to switch. To determine whether these conditions are met, the circuit 55 for example takes into account information delivered by a sensor system, defined below, and/or information delivered by the control module 1, and executes a method or an algorithm to determine whether, in light of this information, the opening conditions are met and the switch 54 must be switched. Preferably, these opening conditions are met in case of detection of an electrical fault, especially in the pole to which the power module 5 is connected, but also preferably in the poles to which the other power modules 5 are connected. Preferably, the circuit 55 may also detect actuation of the control 70, this being another form of opening condition. Preferably, the circuit 55 may also command the switch 54 to switch to the off state when the circuit 55 receives a break order from the control module 1 or from another power module 5, this being another form of opening condition.

In respect of its operation, the circuit 55 is electrically powered by an auxiliary electrical power supply. Advantageously, this auxiliary electrical power supply is delivered by the control module 1, as explained below, or by an exterior source.

The control module 1 (illustrated alone in FIGS. 7 and 8) comprises a tripping device 10 and a control circuit 30 that is referred to as the “main” control circuit.

In the present example, the tripping device 10 comprises a tripping mechanism 11, an electric actuator 12 and a manual control 20 that is referred to as the “general” manual control.

The function of the tripping device 10 is to mechanically trip switching of the mechanical disconnectors 53 of the modules 5, between the conduction configuration and the separation configuration, on command by the control circuit 30 or on being actuated via toggling of the general manual control 20. In order for the tripping device 10 to be able to actuate the disconnectors 53, provision is advantageously made for the tripping device 10 to be mechanically coupled to the mechanical disconnector 53 of the module 5 that is adjacent to the module 1, with a view to making this disconnector 53 switch between the conduction and separation configurations. If there are a plurality of modules 5, the other disconnectors 53 are contiguously actuated in the same way because they are synchronized, preferably using the triggers 67 described above, each actuating the bar-detecting part 67B of the adjacent module 5. By virtue of these measures, if the module 1 actuates the disconnector 53 of the module 5 adjacent it, any other disconnectors 53 belonging to any other modules 5 present are automatically actuated. Only one tripping device 10 is therefore required, whatever the number of modules 5 provided to form the device. It is easy to add or remove a module 5, since it is not necessary to modify the tripping device 10 or the module 1 for all the disconnectors 53 to be actuated contiguously, whatever their number. By virtue of the tripping device 10, the module 1 is able to control, centrally and synchronously, the disconnectors 53 of any module 5 with which the device is equipped.

The tripping mechanism 11 is configured to switch between an armed configuration, corresponding to the conduction configuration of the disconnectors 53, and a tripped configuration, corresponding to the separation configuration of the disconnectors 53. The tripping mechanism 11 preferably operates in a similar way to the tripping mechanism 62 of the power module 5, except that the mechanism 11 advantageously does not need to actuate separable contacts directly since the control module 1 is advantageously not provided therewith.

The mechanism 11 advantageously comprises a spring 14, a bolt 15, a pivoting deck 16, a tripping bar 17 and a keeper 19.

The deck 16 is mounted so as to be able to pivot with respect to the compartment 41. The spring 14 exerts a force on the deck 16 that tends to pivot the deck 16.

The bolt 15 and the keeper 19 form a locking system for the mechanism 11, which is borne by the deck 16. Preferably, the bolt 15 is mounted so as to be able to pivot on the deck 16 and the keeper 19 is mounted so as to be able to pivot on the deck 16, the keeper 19 and bolt 15 being subjected to a force by a locking spring, which tends to return them to the locking configuration. This locking system allows, when it is locked and when the mechanism 11 is in armed configuration, the deck 16 to be kept in an armed orientation. This locking system further allows, when it is released via actuation of the bolt 15 or of the keeper 19 against the force of the locking spring, the deck 16 to be permitted to pivot under the action of the spring 14. When this is done, the spring 14 makes the mechanism 11 switch from the armed configuration to the tripped configuration. The keeper 19 and the bolt 15 may each be independently actuated against the force of the bolt spring, to release the locking system.

The tripping bar 17 is here mounted so as to be able to pivot with respect to the compartment 41. The tripping bar 17 is driven by the deck 16, when the mechanism 11 passes from the tripped configuration to the armed configuration. The tripping bar 17 may also drive the bolt 15 to trip the mechanism 11, when the bar 17 is actuated by the mechanism 62 of the adjacent modules 5, as explained below. Under the force of the locking spring, the bolt 15 drives the bar 17 in the opposite direction when the mechanism 11 passes from the armed configuration to the tripped configuration. Thus, the position of the tripping bar 17 changes depending on whether the mechanism 11 is in armed configuration or in tripped configuration.

Except for one end of the bar 17 (shown in FIG. 7), the mechanism 11 is entirely accommodated inside the control compartment 41.

In the present example, provision is made for the tripping device 10 and the disconnector 53 of the adjacent module 5 to be mutually coupled via their respective mechanism 11 and 62. In particular, provision is made for the bar 17 to mechanically link the two adjacent mechanisms 11 and 62, via passage through a notch provided in the side 46 of the module 1 and a notch provided in the side 44 of the adjacent module 5. The bar 17 is coupled with the bar-detecting part 67B of the adjacent module 5. In the case where the adjacent modules 1 and 5 are inverted, or in the case where the module 1 is placed between two modules 5 that are adjacent to it, provision may be made for the bar 17 to comprise a notch for accommodating the bar 67A of the adjacent module 5, the bar 67A of this module 5 passing through a notch provided in the side 44 of the module 1 and a notch provided in the side 46 of this adjacent module 5.

In any case, the tripping bars 17 and 67A of all the modules are coupled, via mechanical interaction, either because they bear against one another and/or because they are mechanically secured to one another. Thus, when the mechanism 11 passes from the armed configuration to the tripped configuration, the bar 17 drives the trigger 67 of the one or more adjacent modules 5 so that the mechanisms 62 also pass from the armed configuration to the tripped configuration, making the disconnectors 53 switch from the conduction configuration to the separation configuration. Under the action of the tripping device 10, then contiguously, all the locking systems 65, and therefore all the mechanisms 62, of the device are thus mechanically tripped by the bar 17 of the tripping device 10 and through synchronization via the tripping bars 67A.

Preferably, reciprocally, when the adjacent mechanism 62 passes from the armed configuration to the tripped configuration, the bar 67A or the part 67B drives the bar 17 via its bar 67A or its part 67B, to make the mechanism 11 switch from the armed configuration to the tripped configuration. The bar 17 thus driven by the adjacent module 5 actuates the bolt 15, this tripping switching of the mechanism 11.

When the mechanism 11 is in the armed configuration, the spring 14 is stretched to form a store of mechanical potential energy, and retained by the locked configuration of the bolt 15 and of the keeper 19. To make the mechanism 11 switch to the tripped configuration, the bolt 15 is moved under the action of the bar 17 or of the actuator 12 described below, or the keeper 19, under the action of the general manual control 20 described below, this permitting the deck 16 to pivot. The spring 14 then makes the deck 16 pivot, driving therewith the bolt 15 and the keeper 19. During this movement, the bolt 15 drives the bar 17. The bar 17 is then moved with respect to the casing 4, making the disconnector 53 of the adjacent module switch to separation configuration.

To return the mechanism 11 from the tripped configuration to the armed configuration, the mechanism 11 is actuated, for example via the keeper 19 under the action of the general manual control 20 or of the deck 16 under the action of the bar 17 against the force of the spring 14, this re-stretching the spring 14 with a view to future tripping. When this return to armed configuration is achieved by actuating the keeper 19, the bar 17 returns the adjacent disconnector 53 to conduction configuration, by returning the mechanism 62 to armed configuration. When the armed configuration is reached by the mechanism 11, the bolt 15 and the keeper will have again reached the locking configuration, under the action of the locking spring thereof, so as to once again prevent the spring 14 from switching the mechanism 11 to the tripped configuration. In armed configuration, the mechanism 11 keeps itself in the armed configuration until the bolt 15 and the keeper 19 are again released.

The general manual control 20 is a mechanical control. The control 20 is borne by the front 42 of the control compartment 41, in order to be able to be manually actuated by the engineer during use of the device, from outside the casing 4. The control 20 is actuatable to make the mechanism 11 of the tripping device 10 switch between the armed configuration and the tripped configuration. Therefore, by actuating the control 20, the engineer may actuate all the disconnectors 53 at once, by controlling the tripping device 10, and make them switch between the conduction and separation configurations.

For example, the control 20 comprises a toggle switch 21, which juts out toward the exterior of the compartment 41, from the front 42, so as to be manually actuatable by the engineer. For example, the control 20 also comprises a linking rod 22 for mechanically linking the mechanism 11 to the toggle switch 21. The linking rod 22 is here attached to the keeper 19. The toggle switch 21 is moveable between a closed position, which is shown in the figures, and which corresponds to the conduction configuration of the disconnectors 53 and to the armed configuration of the mechanism 11, and an open position, which corresponds to the separation configuration 53 of the disconnectors 53 and to the tripped configuration of the mechanism 11.

When the mechanism 11 is in armed configuration and the toggle switch 21 is moved to the open position, from the closed position, the toggle switch 21 unlocks the bolt 15 via the linking rod 22, actuating the keeper 19. When the spring 14 places the mechanism 11 in tripped configuration, the mechanism 11, on passing to the tripped configuration, drives the toggle switch 21 to the open position via the linking rod 22, which itself is driven by the keeper 19.

When the mechanism 11 is in tripped configuration and the toggle switch 21 is moved to the closed position, from the open position, the toggle switch 21 drives the mechanism 11, via the linking rod 22 actuating the keeper 19, to the armed configuration, against the force of the spring 14, thus stretching the spring 14, until the armed configuration is reached.

If the one or more modules 5 comprise a control 70 such as described above, provision is advantageously made for the controls 70 of the module 5 adjacent the module 1 to be mechanically coupled to the control 20 so that, when one of the controls 20 or 70 is actuated, the other control 20 or 70 is actuated in the same way. To this end, preferably, provision is for example made for the toggle switch 21 and the toggle switch 71 to be mechanically secured to each other. To be secured, provision is for example made for the toggle switches 21 and 71 to be linked to each other by a linking part, or for them to be complementary. Contiguously, all the toggle switches 21 and 71, and therefore all the controls 20 and 70 of the device, are secured to one another and synchronized.

As a variant, the modules 5 are not provided with the control 70, since the control 20 of the module 1 may suffice to actuate the disconnectors 53 of the modules 5. However, provision may be made for the modules 5 to nonetheless be equipped with the control 70, this allowing the modules 5 to be used for other purposes where their control 70 is indispensable, and especially to use the modules 5 without the module 1, separately from the context of the device described here.

The electric actuator 12 is placed inside the control compartment 41. The function of the electric actuator 12 is to actuate the tripping device 10, via the mechanism 11, on command by the main control circuit 30. It is via the electric actuator 12 that the control circuit 30 is able to control the tripping device 10.

In practice, the electric actuator 12 comprises a fixed portion 13 and a mobile portion 18, here a mobile finger. The electric actuator 12 here takes the form of a low-power relay. The electric actuator 12 is coupled to the control circuit 30, i.e. it drives the electric actuator 12. When the control circuit 30 commands the electric actuator 12 to actuate the tripping device, the mobile portion 18 is moved with respect to the fixed portion 13, to actuate the bolt 15, thereby releasing it. The mechanism 11 then passes from the armed configuration to the tripped configuration, under the action of the spring 14.

The main control circuit 30 is placed inside the control compartment 41. Preferably, the control circuit 30 comprises a processor, such as a programmable microcontroller or a microprocessor. The processor is advantageously coupled to a computer memory, or to any computer-readable data storage medium that contains a program, i.e. executable instructions and/or software code. As variants (not described in detail), the control circuit 30 may comprise a digital signal processor (DSP), or a field-programmable gate array (FPGA), or an application-specific integrated circuit (ASIC), or any equivalent element or any combination of these elements.

The control circuit 30 is in communication with all the control circuits 55 with which the power modules 5 are respectively equipped. To this end, the circuit 30 is connected to each circuit 55 via a respective wired connection 59, by a ribbon cable for example. Preferably, each circuit 55 is connected to the circuit 30 by a respective wired connection 59, which passes through the sides 44 and 46 of the various compartments 41 and 45, so as to connect the compartment 41 to the compartment 45 of the module 5 to be connected. The connections 59 are entirely accommodated inside the casing 4. As a variant, the connections 59 may be wireless, or achieved using other interconnection communication schemes than those described here.

By executing the program, the control circuit 30 commands the tripping device 10 to trip switching of the disconnectors 53 of the modules 5, when opening conditions are met. By “opening conditions”, what is meant is one or more conditions that, when they are considered to be met by the control circuit 30, result in the circuit 30 ordering the tripping device 10 to trip switching of the disconnectors 53 of the modules 5. To determine whether these conditions are met, the circuit 30 takes into account information generated by the sensor system, defined below, and/or information delivered by the power modules 5, and executes a method or an algorithm to determine whether, in light of this information, the opening conditions are met and the tripping device 10 must be switched. The control circuit 30 may thus command the control circuits 55 so as to make the switches 54 switch between the on and off state, by sending a breaking order to the circuits 55 in question via the connections 59. The breaking order generated by the control circuit 30 is then an opening condition that, for the local control circuit 55, is met.

The opening conditions for switching the tripping device 10 are not necessarily the same as those for switching the switches 54. Therefore, provision may be made for first opening conditions for the circuits 55 and for second opening conditions for the circuit 30.

Preferably, the control circuit 30 comprises a remote-communication interface 39. This communication interface 39 is for example formed by an electronic component or a suitable communication board, interconnected with the processor and/or the other aforementioned components of the circuit 30. The communication interface 39 is here configured to communicate with a remote device 92, such as a human-machine interface or a fixed or mobile terminal, so that a person or a machine may perform operations on the installation, via the device. Preferably, this communication is achieved via a wired connection between the communication interface 39 and the interface or the terminal of the user, via a connection terminal 31 belonging to the control module 1. For example, the terminal 31 opens onto the exterior of the casing 4, and in particular onto the exterior of the compartment 41, here on the bottom of the compartment 41. The remote device 92 is distinct from the device itself. The connection terminal 31 here takes the form of a data connector.

The remote device 92 may for example send an order for the device to be placed in open, intermediate or closed configuration, via the communication interface. On receiving this order, provided that other conditions are optionally met, the control circuit 30 acts accordingly on the disconnectors 53, via the tripping device 10, and/or on the switches 54, via the circuits 55 of the power modules 5. When it orders the circuit 30 via the communication interface 39 to place the disconnectors 53 in separation configuration, the opening conditions are considered by the circuit 30 to have been met.

The program executed by the local circuit 55 makes it possible to detect an electrical fault such as current overload, a short-circuit, a differential current or presence of a series (or differential) arc in the pole to be protected, but also overvoltages or undervoltages. To this end, the circuit 55 advantageously comprises the aforementioned sensor system, provided within the power compartment 45 of the same power module 5. In the present example, the sensor system comprises a sensor 84, which is a current sensor, measuring the electrical current flowing between the terminals 51 and 52, and in particular between the disconnector 53 and the switch 54. However, provision may be made for the sensor system to comprise more sensors for detecting electrical faults, such as other current sensors, a voltage sensor or a temperature sensor, placed within the power compartment 45 of the same module 5.

Provision may also be made, to detect an electrical fault, for the local circuit 55 to use information output by sensor systems of other power modules 5, output by the control module 1 and/or sensors with which the electrical power supply 90 and/or load 91 are/is equipped. Provision may also be made for the program executed by the main circuit 30 to allow an electrical fault such as those mentioned above to be detected, using the information delivered by one or more circuits 55, which information is itself based on information output by sensor systems integrated into the modules 5.

Preferably, when one of the circuits 55 detects an electrical fault, it communicates this information to the circuit 30, which gives a breaking order to all the circuits 55, so that all the switches 54 are placed in the off state. Once the switches 54 have been placed in the off state, the circuit 30 controls the tripping device 10 so as to place the disconnectors 53 in separation configuration. Alternatively, provision may be made for the circuit 55 that detected the electrical fault to consider that the opening conditions have been met directly and to command the switch 54 to switch to the off state directly, while communicating to the control circuit 30 to give the order to break the other circuits 55.

When the electrical fault has disappeared, and optionally when ordered to do so by a user via the communication interface, the circuit 30 orders the tripping device 10 to make the disconnectors 53 switch to conduction configuration, then commands all the circuits 55 to place the switches 54 in the on state. Alternatively, the disconnectors 53 may be switched to conduction configuration manually by the user using the controls 20 and/or 70, before the circuit 30 commands the circuits 55 to place the switches 54 in the on state. Regarding the disconnectors 53, provision may optionally be made for a person to have to necessarily use the manual control 20 and/or 70 to make the disconnectors 53 switch to conduction configuration, this making it possible to provide an electric actuator 12 that is less powerful and/or self-powering.

The program executed by the local circuit 55 advantageously allows an action on the control 70 to be detected. To this end, the sensor system advantageously comprises a control sensor 85, provided within the power compartment 45 of the same power module 5. The control sensor 85 is designed to detect switching of the control 70 between the closed position and the open position. To do this, the sensor 85 for example detects movement of one portion of the mechanism such as the deck 66 or the locking system 65. For example, the sensor 85 is a mechanical sensor such as a push button, or a remote sensor such as an optical or magnetic sensor. Provision is made for the control sensor 85 to make it possible to detect that the control 70 has been actuated before the disconnector 53 is actually switched to the separation configuration, and even before the contacts 60 and 61 are separated.

Preferably, when one of the circuits 55 detects an action on the control 70, it communicates this information to the circuit 30, which gives a breaking order to all the circuits 55, so that all the switches 54 are placed in the off state before the command 70 has switched the disconnectors 53 to separation configuration. This prevents formation of an electric arc between the contacts 60 and 61 if the installation is on load. Once the switches 54 have been placed in the off state, the circuit 30 controls the tripping device 10 so as to place the disconnectors 53 in separation configuration. Alternatively, provision may be made for the circuit 55 that detected the action on the control 70 to consider that the opening conditions have been met directly and to command the switch 54 to switch to the off state directly, while communicating to the control circuit 30 to give the order to break the other circuits 55.

The program executed by the main circuit 30 advantageously allows an action on the control 20 to be detected. To this end, the sensor system advantageously comprises a control sensor 25, provided within the power compartment 45 of the same power module 5. The control sensor 85 is designed to detect switching of the control 70 between the closed position and the open position. To do this, the sensor 85 for example detects movement of one portion of the mechanism such as the deck 16 or the bolt 15. For example, the sensor 25 is a mechanical sensor such as a push button, or a remote sensor such as an optical or magnetic sensor.

Preferably, when the circuit 30 detects an action on the control 20, it gives a breaking order to all the circuits 55, so that all the switches 54 are placed in the off state before the command 20 has switched the disconnectors 53 to separation configuration via action on the tripping device 10. This prevents formation of an electric arc between the contacts 60 and 61 if the installation is on load. Since the switches 54 are placed in the off state very rapidly, separation of the contacts 60 and 61 under the mechanical action of the tripping device 10 occurs afterwards.

Preferably, the control module 1 comprises an auxiliary power supply component 34, configured to electrically power the main control circuit 30, with a view to operation thereof. In this regard, the component 34 delivers auxiliary electrical power to the control circuit 30, by being electrically connected to the circuit 30. This supply of power allows the circuit 30 to operate, but also the tripping device 10. Preferably, the tripping device 10 is supplied with power by the auxiliary electrical power supply via the circuit 30, or otherwise directly by the component 34. Preferably, the auxiliary component 34 is placed entirely inside the compartment 41.

Preferably, each local control circuit 55 is electrically powered by the auxiliary electrical power supply via the main control circuit 30. Provision is advantageously made for each local control circuit 55 to power the switch 54 of the same module 5 with the auxiliary electrical power supply, with a view to operation thereof.

In order for the circuit 30 to power the circuits 55, provision is for example made for wires to connect each control circuit 55 to the circuit 30 with a view to transmission of this auxiliary power. Preferably, provision is made for specific conductors within the wired connections 59 so as to ensure this supply of auxiliary electrical power to the circuits 55. When these connections 59 are ribbon cables, connecting the circuits 55 to the circuit 30 not only allows the circuits 55 and 30 to be placed in communication, but also allows the circuits 55 to be supplied with auxiliary electrical power by the circuit 30. As a variant, each circuit 55 is supplied with power by the component 34 directly, by being connected to the component 34 in a similar way.

Whatever solution is adopted, in respect of operation of the circuits 55, the number of connections to an auxiliary electrical power supply is decreased, since a single auxiliary electrical power supply is provided in the control module 1, and is distributed to the circuits 30 and 55. This also makes it possible to easily modify the number of power modules 5 installed in the device, because disconnection of one of these modules 5 leaves the other modules 5 connected by their own wired connection 59.

As illustrated in FIG. 9, to deliver the auxiliary electrical power supply, the component 34 is advantageously connected to the poles of the installation so that electrical power is obtained from the electrical power supply 90. The component 34 is for example connected to the poles within two separate power modules 5. This arrangement has the advantage that the auxiliary electrical power supply may be said to be “self-powering”, i.e. it requires no other source than that provided by the electrical power supply 90 itself.

In this case, for example, the component 34 advantageously comprises two wired connections 35 that connect the component 34 to two respective poles. The first wired connection 35 electrically connects the component 34 to a first module 5, by being connected for example between the disconnector 53 and the static switch 54. The second wired connection 35 electrically connects the component 34 to a second module 5, by being connected for example between the disconnector 53 and the static switch 54.

As a variant, the component 34 advantageously comprises two wired connections 36 (shown in FIG. 9) that connect the component 34 to two respective poles, but downstream of the static switches 54.

When wired connections 36 are provided, provision is made for the first wired connection 36 to electrically connect the component 34 to a first module 5, by being connected for example between the static switch 54 and the terminal 52, and for the second wired connection 36 to electrically connect the component 34 to a second module 5, by being connected for example between the static switch 54 and the terminal 52.

In FIG. 9, connections 35 and 36 to a single module 5 have been shown for the sake of simplicity, since only a single power module 5 has been shown. In practice, these connections 35 and 36 are in fact connected to two separate modules 5 as explained above. In practice, provision is made for the device to comprise either connections 35, or alternatively connections 36, depending on the features of the installation and on the electrical faults that are liable to occur.

As a variant, provision may be made for the device to comprise both connections 35 and connections 36, so that the device is able to handle any situation.

In this case as well, the component 34 advantageously comprises means for electrically converting the voltage drawn from the electrical power supply 90 into a voltage suitable for supplying the circuits 30 and 55, this means for example including a transformer, a rectifier, an inverter and/or any suitable protection and conversion component. For example, the auxiliary electrical power supply delivered by the component 34 is a DC voltage of less than 100 V, for example 24 or 48 V. The component 34 may also incorporate means for storing electrical power, such as a pack of batteries, in order to be able to continue to ensure the circuits 30 and 55 are supplied with auxiliary electrical power even when the electrical power supply 90 has been cut. In the case of a self-powering supply, is particularly advantageous for the electric actuator 12 to consist of a low-power relay.

As a variant or in addition, the component 34 may be electrically connected to a specific external auxiliary electrical power supply, distinct from the electrical power supply 90. For example, the component 34 may be electrically connected via the connection terminal 31, or via another external terminal. In this case as well, provision may be made for the component 34 to comprise means for converting and/or storing auxiliary electrical power, in case the auxiliary electrical power supply should be cut. The external auxiliary electrical power supply is particularly suitable in the case where the electric actuator requires a relatively high power to operate. For example, this makes it possible to make provision for the electric actuator to be a linear electric actuator, with a coiled stator and a mobile core actuated to translate by the stator, the mobile core being accommodated within the stator and actuating the mechanism 11 and especially the bolt 15. This type of electric actuator allows remote control of the device to be facilitated, since it may be powerful enough to make the mechanism 11 switch from the tripped configuration to the armed configuration, this not always being possible with a low-power relay.

Preferably, the power module 5 does not incorporate an individual auxiliary power supply, this avoiding hardware redundancy with the auxiliary electrical power supplied provided in the module 1. However, as a variant, provision may be made for the module 5 to nonetheless incorporate an auxiliary electrical power supply component, which directly powers the circuit 55 independently of the aforementioned component 34. In this case, for example, the auxiliary electrical power supply component has a structure and operation similar to the component 34 described above, except that it powers the circuit 55 and that it is placed in the power compartment 45.

Preferably, the power module 5 does not incorporate an electric actuator for actuating the disconnector 53, this avoiding redundancy with the tripping device 10 of the module 1. Preferably, provision is made for it to be possible to actuate only the disconnector 53 by actuating the control 70 or the control 20, or else when the circuit 30 actuates the disconnector 53 via the tripping device 10.

Preferably, the control module 1 does not incorporate power terminals, a power switch or a power disconnector, since these are exclusively provided in the power modules 5. This avoids redundancy.

One advantage of making provision for the opening conditions to be stored in the circuits 30 and/or 55 is to make it possible to reprogram the circuits 30 and/or 55 of the device, so that the device may be modified specifically to change these conditions. This change of the opening conditions may be made, either during manufacture, or throughout the lifespan of the device or of the module 1 or 5 in question. It is thus possible to adapt the opening conditions to new standards, to a new installation, or to a change to the device, especially in respect of the number of power modules 5 installed.

Any feature described above with regard to one embodiment or variant is applicable to the other embodiments and variants, provided that it is technically possible.

1. A control module, configured to be integrated into a modular electrical protection device also comprising at least one power module, the control module comprising:
a control compartment, intended to form one portion of a casing belonging to the modular electrical protection device;
a tripping device, able to mechanically trip switching of a mechanical disconnector belonging to said at least one power module, from a conduction configuration to a separation configuration; and
a main control circuit, which is:
placed inside the control compartment,
configured to be in communication with a local control circuit belonging to said at least one power module, the local control circuit being configured to command into an off state a static switch belonging to said at least one power module, and
configured to command the tripping device to trip switching of the mechanical disconnector, when opening conditions are met.

2. The control module according to claim 1, wherein the tripping device comprises:
a tripping mechanism placed in the control compartment and configured to switch between an armed configuration and a tripped configuration; and
a tripping bar, which juts out of the control compartment into said at least one power module, the tripping bar being moved when the tripping mechanism transitions from the armed configuration to the tripped configuration, so that the tripping bar mechanically trips switching of the mechanical disconnector of the power module, from the conduction configuration to the separation configuration.

3. The control module according to claim 1, wherein the tripping device comprises a general manual control, which is borne by the control compartment and which is actuatable from outside the control compartment so as to command the tripping device to switch the disconnector of said at least one power module from the conduction configuration to the separation configuration.

4. The control module according to claim 1, wherein the tripping device comprises an electric actuator, which is placed inside the control compartment and which is controlled by the main control circuit, the main control circuit controlling the tripping device by controlling the electric actuator.

5. A power module, configured to be integrated into a modular electrical protection device also comprising a control module, the power module comprising:
a power compartment, intended to form one portion of a casing belonging to the modular electrical protection device;
an input terminal, able to be connected to an electrical power supply;
an output terminal, able to be connected to a load intended to be electrically powered by the electrical power supply via said at least one power module;
a mechanical disconnector, via which the terminals are electrically connected, which comprises separable contacts placed inside the power compartment, the mechanical disconnector being configured to switch between a conduction configuration, in which the separable contacts make mutual contact so as to conduct electrical current between the input terminal and the output terminal, and a separation configuration, in which the separable contacts are separated by an air gap so as to electrically separate the output terminal from the input terminal, the mechanical disconnector being configured so that switching from the conduction configuration to the separation configuration is able to be mechanically tripped by a tripping device belonging to the control module;
a static switch, via which the terminals are electrically connected, which is connected in series with the mechanical disconnector and which is configured to transition between an on state, for conducting electrical current between the input terminal and the output terminal, and an off state, for electrically isolating the output terminal from the input terminal; and
a local control circuit, configured to command the static switch into the off state when opening conditions are met and to be in communication with a main control circuit belonging to the control module and controlling the tripping device.

6. The power module according to claim 5, wherein the mechanical disconnector comprises a local manual control, which is borne by the power compartment and actuatable from outside the power compartment so as to switch the mechanical disconnector between the conduction configuration and the separation configuration.

7. The power module according to claim 6, wherein, to determine whether the opening conditions are met, the local control circuit comprises a sensor system comprising:
a current sensor, measuring the electrical current flowing between the terminals; and/or
a control sensor, detecting actuation of the local manual control.

8. A modular electrical protection device, comprising:
a casing;
at least one power module according to claim 5, the power compartment forming one portion of the casing; and
a control module comprising:
a control compartment, intended to form one portion of a casing belonging to the modular electrical protection device;
a tripping device, able to mechanically trip switching of a mechanical disconnector belonging to said at least one power module, from a conduction configuration to a separation configuration; and
a main control circuit, which is:
placed inside the control compartment,
configured to be in communication with a local control circuit belonging to said at least one power module, the local control circuit being configured to command into an off state a static switch belonging to said at least one power module, and.
configured to command the tripping device to trip switching of the mechanical disconnector, when opening conditions are met, the control compartment forming one portion of the casing, the tripping device being able to mechanically trip switching of the mechanical disconnector of said at least one power module from the conduction configuration to the separation configuration, the main control circuit being in communication with the local control circuit of said at least one power module.

9. The modular electrical protection device according to claim 8, wherein the main control circuit comprises a remote-communication interface, for communicating with a remote device distinct from the modular electrical protection device.

10. The modular electrical protection device according to claim 8, wherein
the main control circuit is supplied with electrical power by an auxiliary electrical power supply; and
the local control circuit of said at least one power module is electrically connected to the control module so that said local control circuit is electrically powered by the auxiliary electrical power supply, via the control module.

11. The modular electrical protection device according to claim 10, wherein the control module comprises an auxiliary electrical power supply component, which is placed in the control compartment and connected to the electrical power supply, the auxiliary electrical power supply component delivering auxiliary electrical power to the main control circuit via conversion of the electrical power supply.

12. The modular electrical protection device according to claim 11, wherein the auxiliary electrical power supply component is connected to the electrical power supply by being electrically connected to two power modules of the device, using wired connections, each wired connection being connected to its power module between the input terminal and the output terminal.
